(19) United States
(12) Patent Application Publication
(10) Pub. No.: US 2008/0148962 A1
(43) Pub. Date: Jun. 26, 2008

(54) Large Kitchen Professional Oven With Microwave Energy Confined Within the Cooking Cavity

(75) Inventor: Gerard Beausse, Charenton (FR)

Correspondence Address: THOMPSON HINE LLP;Intellectual Property Group, P.O Box 8801, DAYTON, OH, 45401-8801, US

(73) Assignee: PREMARK FEG L.L.C., Wilmington, DE (US)

(21) Appl. No.: 11/911,759

(22) PCT Filed: Apr. 18, 2006
(86) PCT No.: PCT/US2006/014774

§ 371 Date: Oct. 17, 2007

(30) Foreign Application Priority Data
Apr. 22, 2005 (FR) 0504046
Apr. 18, 2006 (US) PCT/US2006/014774

(51) Int. Cl. F24C 7/02; H05B 6/80; H05B 6/64

(52) U.S. Cl. 99/339; 219/682

(57) ABSTRACT

This is an oven with at least dual heating by microwaves (10), on the one hand, and by indirect steam (12), on the other, comprising a cooking cavity (1) and an external steam generator, connected to the cavity (1) by a steam supply pipe emerging in the cavity (1) through an opening (3). An obstacle to microwave radiation (136) is arranged in the said opening (3).

The invention relates to what are called “grande cuisine” professional ovens. This term is applied to ovens having an internal capacity of at least approximately 0.15 m³. Several types of “grande cuisine” ovens exist.

Ovens with convection heating include, inside the cooking cavity of the oven, a gas burner or one or more heating resistances and one or more convection fans.

Certain ovens with steam heating include a steam generator external to the cavity. These are ovens with indirect steam production.

Other ovens with steam heating include, inside the cavity, at least one fan associated with a heating resistance or a gas burner onto which water is projected to produce steam directly inside the oven.

Combi or combined ovens are known, which have dual heating by convection and by steam, as do, moreover, certain of those mentioned above. Combi ovens have tended to replace the others for some time now.

Lastly, yet another category of professional “grande cuisine” ovens is known, which combines at least one of convection heating and steam heating with microwave heating. These ovens are described in particular in the patent U.S. Pat. No. 6,452,142 of the company Appollo USA, Inc..

The invention of the present application relates more particularly to a professional “grande cuisine” oven with at least combined dual heating by indirect steam and microwaves. Such an oven therefore includes an external steam generator, i.e. a boiler, connected to the oven cavity by a pipe which emerges in the cavity through a hole formed in the cavity wall. Now, the applicant has realised that, at hyperfrequencies, an opening is a radiating device and that, consequently, a part of the microwave power injected into the oven cavity radiates through this steam supply hole.

It is to palliate this disadvantage that the invention of the present application is proposed and it thus relates to a professional “grande cuisine” oven with at least dual heating by microwaves, on the one hand, and by indirect steam, on the other, comprising a cooking cavity and an external steam generator connected to the cavity by a steam supply pipe emerging in the cavity through an opening, which oven is characterised by the fact that an obstacle to microwave radiation is arranged in the said opening.

Thus, and by means of the invention, a larger part of the hyperfrequency energy injected into the cooking cavity of the oven by the magnetrons remains confined there.

Preferably, the obstacle to microwave radiation extends inside the steam supply pipe.

Preferably, the said obstacle is a capacitive obstacle, advantageously comprising at least two metal strips extending parallel with the electrical field.

In the preferred embodiment of the oven of the invention, the obstacle is a double cross-piece of two pairs in a cross of two parallel metal strips.

The invention will be better understood with the assistance of the following description of the oven of the invention, with reference to the attached drawings, in which

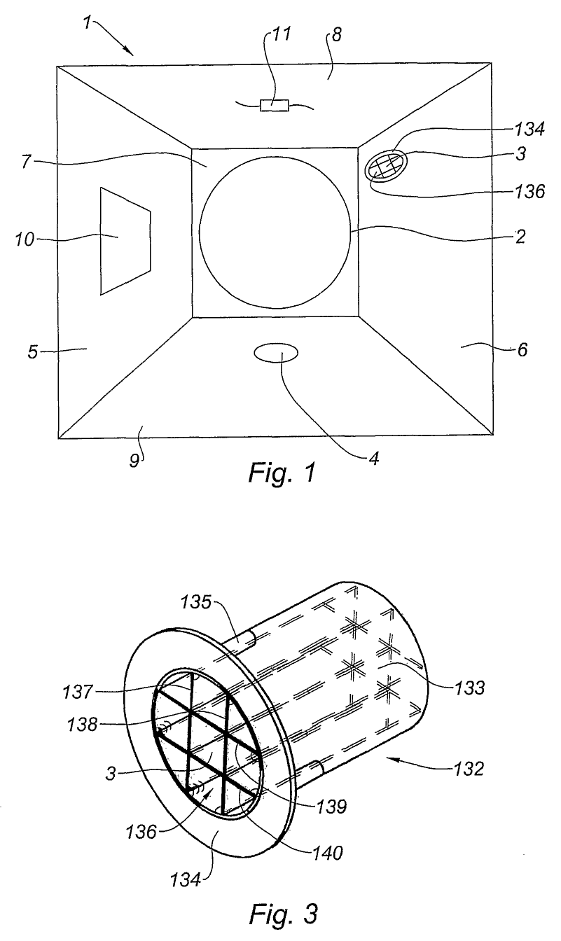

FIG. 1 is a simplified perspective view of the cooking cavity of the oven;

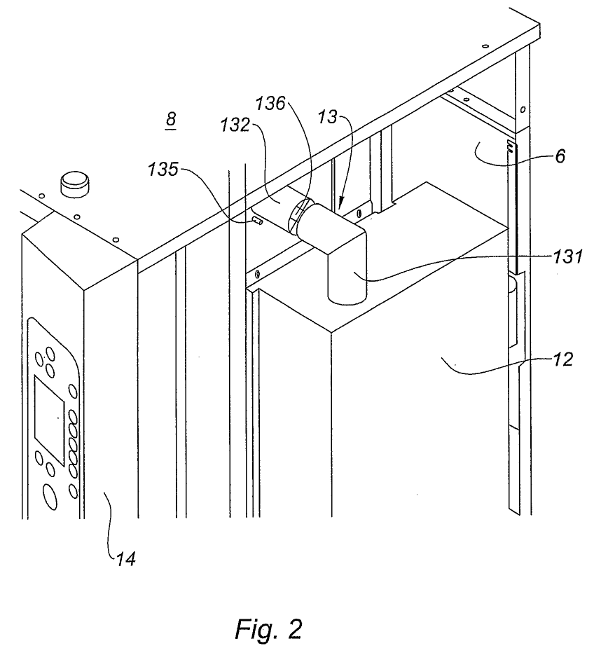

FIG. 2 is a perspective view of the outside of the wall of the oven cavity carrying the boiler with its steam supply pipe and

FIG. 3 is a perspective view to a larger scale of the cross-piece obstacle to hyperfrequency radiation.

The oven which will now be described is a professional “grande cuisine” oven with microwave heating combined with combi heating by convection and by steam.

The cooking cavity 1, of parallelepipedal form, is defined by two lateral walls 5, 6, a back wall 7, a ceiling wall 8 and a floor wall 9. In operation, the cavity is closed by a door.

Thus, inside the cavity, shown diagrammatically, are a heating resistance 2, against the back wall 7, a cup 10 for injection of the magnetron radiation, on the left lateral wall 5, a steam supply hole 3, in the right lateral wall 6, a spray bulb 11, for washing, on the ceiling wall 8, and an emptying cap 4, on the floor wall 9.

To the outside of the right lateral wall 6 (FIG. 2) is fixed a steam generator 12, in this case a boiler. The boiler is connected to the inside of the cavity 1 by a steam supply pipe 13 emerging in the cavity through the hole 3.

FIG. 2 also shows a front control console 14.

The steam supply pipe is in two parts, a first 131, at the output of the boiler 12, and a second 132, at the entry to the cooking cavity. The second part 132 of the supply pipe is a pipe forming an obstacle to microwave radiation, in which is mounted a cross-piece of metal strips shown in FIG. 2.

A sleeve, not shown in FIG. 2, is mounted slidingly on the two free ends of the two pipe parts 131, 132 to complete them and provide the continuity of the steam supply pipe.

The pipe part 132 forming an obstacle to hyperfrequency radiation includes a tubular element 133 carrying, at the end opposite to that by which it is joined to the other steam supply pipe part 131, a flange 134 providing a function of abutment against the lateral wall 6 when this pipe part 132 is fixed to the wall 6 by ties 135. The flange 134 provides the steam supply hole 3.

The cross-piece of metal strips 136 extends inside the tubular element 133, along its whole length from the plane of the flange 134, i.e. the plane of the hole 3. The cross-piece 136 is a capacitive obstacle. It is a double cross-piece which includes two metal strips 137, 138, parallel with the electrical field, separated from each other by a distance less than λ/2, λ being the wavelength of the hyperfrequency radiation, and preferably less than λ/4. The cross-piece also includes two other metal strips 139, 140 which are mutually parallel but perpendicular to the other two, also separated from each other by a distance less than λ/2, and preferably than λ/4. The two pairs of metal strips 137, 138 and 139, 140 are arranged in a cross. Preferably, the diameter of the tubular element 133 is greater than three times the spacing of the capacitive strips of each pair of strips of the double cross-piece.

To give a definite idea, the tubular element may have a diameter of the order of 5 cm.

1. Professional “grande cuisine” oven with at least dual heating by microwaves, on the one hand, and by indirect steam on the other, comprising:
a cooking cavity and an external steam generator, connected to the cavity by a steam supply pipe emerging in the cavity through an opening, wherein an obstacle to microwave radiation is arranged in the said opening.

2. Oven as described in claim 1, in which the obstacle to microwave radiation extends inside the steam supply pipe.

3. Oven as described in, claim 1 in which said obstacle is a capacitive obstacle.

4. Oven as described in claim 3, in which the said obstacle comprises at least two metal strips extending parallel with the electrical field.

5. Oven as described in, claim 4 in which the obstacle is a double cross-piece of two pairs in a cross of two parallel metal strips.

6. Oven as described in claim 5, in which the two metal strips of each pair are separated from each other by a distance less than λ/2, where λ is the wavelength of the microwaves used to heat the oven.

7. Oven as described in claim 6, in which the two metal strips of each pair are separated from each other by a distance less than λ/4.

8. An dual-heating oven, the oven comprising:
a cavity;
a microwave generator for delivering microwave energy into the cavity;
an external steam generator connected to the cavity by a steam supply line emerging in the cavity through an opening; and
an obstacle to microwave radiation positioned in the opening.
